(19) United States
(12) Patent Application Publication
(10) Pub. No.: US 2025/0174995 A1
(43) Pub. Date: May 29, 2025

(54) POWER MANAGEMENT APPARATUS, POWER MANAGEMENT METHOD, POWER MANAGEMENT PROGRAM, FACILITY, AND FREEZER

(71) Applicant: KYOCERA CORPORATION, Kyoto-shi, Kyoto (JP)

(72) Inventors: Noriko SUGITA, Yokohama-shi, Kanagawa (JP); Yuki SUZUKI, Yokohama-shi, Kanagawa (JP); Takeru HIROHASHI, Yokohama-shi, Kanagawa (JP)

(21) Appl. No.: 18/868,718

(22) PCT Filed: May 23, 2023
(86) PCT No.: PCT/JP2023/019102

§ 371 Date: Nov. 22, 2024

(30) Foreign Application Priority Data
May 23, 2022 (JP) 2022-084154

(51) Int. Cl. H02J 3/14; F25D 11/02; G06Q 30/0283; G06Q 50/06; H02J 3/00; H02J 3/28

(52) U.S. Cl. CPC H02J 3/144; F25D 11/02; G06Q 30/0283; H02J 3/003; H02J 3/004; H02J 3/28; G06Q 50/06; H02J 2310/12; H02J 2310/60

(57) ABSTRACT

A power management apparatus collects data related to electric power of a facility comprising a freezer and a power load other than the freezer, estimates total power consumption of the facility with the collected data, and performs a control of the freezer with an estimation result. The power management apparatus performs the control to prioritize a reduction of a peak in the total power consumption of the facility over a reduction of a peak in power consumption of the freezer.

### TECHNICAL FIELD

The present disclosure relates to a power management apparatus, a power management method, a power management program, a facility, and a freezer.

### BACKGROUND OF INVENTION

Patent Document 1 describes a cooling apparatus that includes a cold storage unit having a heat storage material and manually or automatically performs switching between cold storage operation, which cools the heat storage material, and stopping cold storage operation, which performs cooling by cold storage of the heat storage material. In this cooling apparatus, when the switching is automatically performed in response to the operation of the timer, the cool storage operation is performed in a night time zone during the operation of the timer, and the operation of the cooling apparatus is stopped in other time zones.

### CITATION LIST

### Patent Literature

Patent Document 1: JP 2005-201510 A

### SUMMARY

A power management apparatus according to a first aspect includes: a collector that collects data related to electric power of a facility including a freezer and a power load other than the freezer; an estimator that estimates total power consumption of the facility with the data; and a controller that performs a control of the freezer with a result of the estimation. The controller performs the control to prioritize a reduction of a peak in the total power consumption of the facility over a reduction of a peak in power consumption of the freezer.

A power management method according to a second aspect includes: collecting data related to electric power of a facility including a freezer and a power load other than the freezer; estimating total power consumption of the facility with the data; and performing a control of the freezer with a result of the estimation. The performing the control includes performing the control to prioritize a reduction of a peak in the total power consumption of the facility over a reduction of a peak in power consumption of the freezer.

A power management program according to a third aspect causes a computer to execute collecting data related to electric power of a facility including a freezer and a power load other than the freezer, estimating total power consumption of the facility with the data, and performing a control of the freezer with a result of the estimation. The performing the control includes performing the control to prioritize a reduction of a peak in the total power consumption of the facility over a reduction of a peak in power consumption of the freezer.

A facility according to a fourth aspect includes a freezer and a power load other than the freezer. The facility includes: a collector that collects data related to electric power of a facility; an estimator that estimates total power consumption of the facility with the data; and a controller that performs a control of the freezer with a result of the estimation. The controller performs the control to prioritize a reduction of a peak in the total power consumption of the facility over a reduction of a peak in power consumption of the freezer.

A freezer according to a fifth aspect includes: a collector that collects data related to electric power of a facility including the freezer and a power load other than the freezer; an estimator that estimates total power consumption of the facility with the data; and a controller that performs a control of the freezer with a result of the estimation. The controller performs the control to prioritize a reduction of a peak in the total power consumption of the facility over a reduction of a peak in power consumption of the freezer.

### BRIEF DESCRIPTION OF THE DRAWINGS

FIG. 1 is a diagram illustrating a configuration of a power management system according to an embodiment.

FIG. 2 is a diagram illustrating an example of a facility according to the embodiment.

FIG. 3 is a diagram illustrating a configuration of a power management apparatus according to the embodiment.

FIG. 4 is a diagram illustrating a transition of power consumption per day when neither a freezer control apparatus nor the power management apparatus according to the embodiment performs peak reduction control.

FIG. 5 is a diagram illustrating a transition of power consumption per day when the freezer control apparatus according to the embodiment performs peak reduction control.

FIG. 6 is a diagram illustrating a transition of power consumption per day when the power management apparatus according to the embodiment performs peak reduction control.

FIG. 7 is a diagram illustrating a power management method by the power management apparatus according to the embodiment.

FIG. 8 is a diagram for explaining a first modification of the power management system according to the embodiment.

FIG. 9 is a diagram for explaining a second modification of the power management system according to the embodiment.

FIG. 10 is a diagram for explaining a third modification of the power management system according to the embodiment.

FIG. 11 is a diagram for explaining another modification of the power management system according to the embodiment.

### DESCRIPTION OF EMBODIMENTS

In the related art, since closed control is performed by the cooling apparatus (from another viewpoint, the freezer), room for improvement exists in terms of more efficient control of the freezer. For example, this technique has a limited effect of reducing the peak of the total power consumption of a facility having a freezer.

An object of the present disclosure is to enable a freezer to be more efficiently controlled.

A power management system according to an embodiment will be described with reference to the drawings. In the description of the drawings, the same or similar parts are denoted by the same or similar reference signs.

### Configuration of Power Management System

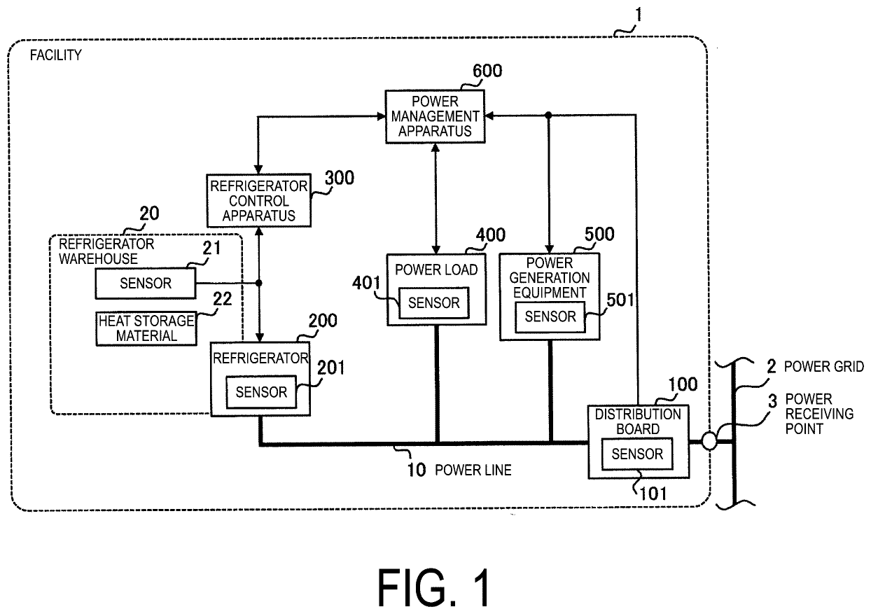

First, a configuration of a power management system according to an embodiment will be described with reference to FIG. 1. As illustrated in FIG. 1, the power management system according to the embodiment includes a distribution board 100, a freezer 200, a freezer control apparatus 300, a power load 400, power generation equipment 500, and a power management apparatus 600 as facilities provided in a facility 1.

The facility 1 is a facility managed by a warehouse company and is a warehouse facility including a freezer warehouse 20. The facility 1 has a power receiving point 3 connected to a power grid 2, and receives power supply from the power grid 2 via the power receiving point 3. The flow of power from the power grid 2 to the facility 1 is also referred to as a tidal current. The facility 1 may be capable of reverse power flow to the power grid 2. The reverse power flow refers to a flow of electric power from the facility 1 to the power grid 2. The power grid 2 is managed by an electric power company (an electric power enterprise, a power generation company, a power transmission and distribution company, or an electric power retailer).

Here, an electric power rate to be paid from the warehouse company to the power company may be determined by an instantaneous peak power (kW) of the power consumption and a power consumption amount (kWh) which is an integrated value of the power consumption. For example, the basic portion of the electric power rate may be determined according to the instantaneous peak power (KW), and the pay-for-use billing portion of the electric power rate may be determined according to the power consumption (kWh). In order to mitigate the shortage of the power grid 2 and stabilize the power grid 2, it is desired to reduce the instantaneous peak power (KW) and the power consumption (kWh).

The distribution board 100 is an apparatus that distributes power from the power grid 2 to the freezer 200 and the power load 400 via a power line 10. The distribution board 100 includes a sensor 101 for detecting the total power consumption of the facility 1 (that is, the tidal power to the facility 1). The distribution board 100 outputs sensor data obtained by the sensor 101 to the power management apparatus 600.

The freezer 200 is a kind of power load that consumes electric power supplied via the power line 10. The freezer 200 is an apparatus for cooling the inside (freezer compartment) of the freezer warehouse 20. The freezer 200 has a general configuration including, for example, a compressor, a condenser, an expansion valve, and an evaporator as constituent elements. The compressor, the condenser, the expansion valve, and the evaporator constitute a refrigeration cycle. The compressor and the condenser may be provided in an outdoor unit outside the freezer warehouse 20. The expansion valve and the evaporator may be provided in an indoor unit in the freezer warehouse 20. The freezer 200 includes a sensor 201 for detecting the temperature of a component of the freezer 200 and/or the power consumption of the freezer 200. The freezer 200 outputs the sensor data obtained by the sensor 201 to the freezer control apparatus 300.

The freezer warehouse 20 is, for example, a warehouse in which stored items such as frozen foods are stored. The freezer warehouse 20 includes a sensor 21 and a heat storage material 22.

The sensor 21 detects an internal temperature of the freezer warehouse 20 and/or opening and closing of a door of the freezer warehouse 20. The sensor 21 may also detect the temperature of the heat storage material 22. The sensor 21 outputs sensor data indicating the detection result to the freezer control apparatus 300.

The heat storage material 22 is used to keep the internal temperature of the freezer warehouse 20 constant, and is also referred to as a phase change material (PCM), a refrigerant, or a latent heat storage material. The heat storage material 22 has characteristics of low thermal resistance and fast heat transfer. The heat storage material 22 has a high specific heat and can store a large amount of cold heat compared to a stored product (for example, frozen food). The temperature of the heat storage material 22 can be set, and heat can be stored and released at a specific temperature generally used in freezing and refrigerating.

The freezer control apparatus 300 is an apparatus that controls the freezer 200. The freezer control apparatus 300 may be connected to a communication network and provided outside the facility 1. The freezer control apparatus 300 controls the freezer 200 with the sensor data of the sensor 21 and the sensor data of the sensor 201. The freezer control apparatus 300 may control the freezer 200 so as to reduce the peak of the power consumption of the freezer 200. For example, the freezer control apparatus 300 performs control to equalize (average) the power consumption of the freezer 200. However, the freezer control apparatus 300 can perform only closed control (that is, sub-optimization) in the freezer 200.

The power load 400 is an apparatus that consumes electric power supplied via the power line 10. The power load 400 includes, for example, at least one selected from the group consisting of an air conditioner, a lighting equipment, a carrier, an automation apparatus, and office equipment. The power load 400 may be controllable from the power management apparatus 600 via a control board. The power load 400 (or the control board) includes a sensor 401 for detecting power consumption and/or an operation state of the power load 400. The sensor 401 outputs sensor data indicating a detection result to the power management apparatus 600.

The power generation equipment 500 is an apparatus that generates power. The power generation equipment 500 outputs the generated power to the freezer 200 and the power load 400 via the power line 10. The power generation equipment 500 may be, for example, solar power generation equipment, a fuel cell facility, wind power generation equipment, geothermal power generation equipment, and/or biomass power generation equipment. Hereinafter, an example in which the power generation equipment 500 is photovoltaic power generation equipment will be mainly described. The power generation equipment 500 includes a sensor 501 for detecting generated power of the power generation equipment 500 and/or an operation state of the power generation equipment 500. The sensor 501 outputs sensor data indicating a detection result to the power management apparatus 600.

The power management apparatus 600 is an apparatus that manages power in the facility 1. The power management apparatus 600 may be connected to a communication network and provided outside the facility 1. The power management 600 collects various kinds of data including sensor data from each piece of equipment (the distribution board 100, the freezer control apparatus 300, the power load 400, and the power generation equipment 500) provided in the facility 1, and estimates the total power consumption of the facility 1 with the collected data, and controls each piece of equipment (particularly, the freezer 200) with the estimation result. A specific example of such estimation will be described below. Here, the power management apparatus 600 collects sensor data about the freezer warehouse 20 and the freezer 200 from the freezer control apparatus 300. The power management apparatus 600 controls the freezer 200 via the freezer control apparatus 300.

As described above, the power management 600 can achieve the overall optimization of the facility 1, not the partial optimization closed by the freezer 200, by considering the overall situation of each piece of equipment in the facility 1 (for example, the power use situation of the power load 400 and the power generation situation of the power generation equipment 500). Specifically, the power management apparatus 600 performs control so as to equalize (average) the total power consumption of the facility 1. In the embodiment, the power management apparatus 600 controls the freezer 200 such that the peak of the total power consumption of the facility 1 is reduced in preference to the reduction of the peak of the power consumption of the freezer 200.

### Example of Facility

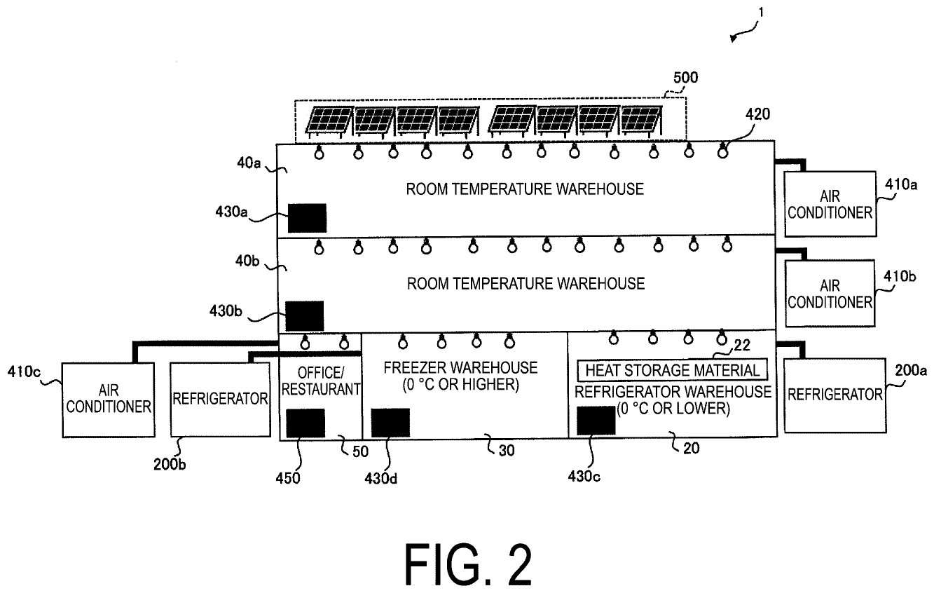

An example of the facility 1 according to the embodiment will be described with reference to FIG. 2. In the example of FIG. 2, the facility 1 is a warehouse facility with three temperature zones, and includes one freezer warehouse 20, one freezer warehouse 30, and two room temperature warehouses 40 (40a, 40b). The facility 1 may further include an office/restaurant 50. However, the facility 1 is not limited to such a warehouse facility with three temperature zones, and may be, for example, “only a freezer warehouse and a freezer warehouse”, “only a freezer warehouse”, “a freezer warehouse in a food factory”, “a food processing factory in a facility of a distribution warehouse (including a freezer warehouse)”, or “a walk-in freezer installed in a grocery store or a large restaurant”.

The inside of the freezer warehouse 20 is cooled by a freezer 200a. The heat storage material 22 is arranged in the freezer warehouse 20. The freezer control apparatus 300 controls the freezer 200a while managing the cold storage heat of the heat storage material 22.

The inside of the freezer warehouse 30 is cooled by a freezer 200b. Although an example in which the heat storage material 22 is not disposed in the freezer warehouse 30 is illustrated, a heat storage material may be disposed in the freezer warehouse 30. The power management apparatus 600 may control the freezer 200a in addition to the freezer 200a or instead of the freezer 200b.

The inside of the room temperature warehouse 40 (40a, 40b) is temperature-controlled by an air conditioner 410 (410a, 410b). The air conditioner 410 (410a, 410b) is an example of the power load 400 other than the freezer 200. The air conditioner 410 (410a, 410b) may be controlled by the power management apparatus 600.

The inside of the office/restaurant 50 is temperature-controlled by an air conditioner 410c. The air conditioner 410c is an example of the power load 400 other than the freezer 200. The air conditioner 410c may be controlled by the power management apparatus 600.

Each of the freezer warehouse 20, the freezer warehouse 30, the room temperature warehouse 40 (40a, 40b), and the office/restaurant 50 is provided with a lighting equipment 420. Each of the freezer warehouse 20, the freezer warehouse 30, and the room temperature warehouse 40 (40a, 40b) is provided with a conveyor/automation apparatus 430 (430a to 430d) and the like. Office equipment 450 and the like are provided in the office/restaurant 50. The lighting equipment 420, the conveyor/automation apparatus 430 (430a to 430d), and the office equipment 450 are examples of the power load 400 other than the freezer 200.

As described above, the facility 1 is provided with various power loads 400 in addition to the freezer 200. Therefore, only by reducing the peak of the power consumption of the freezer 200, the effect of reducing the peak of the total power consumption of the facility 1 is limited. In the embodiment, the power management apparatus 600 controls the freezer 200 (and the power load 400) so as to reduce the peak of the total power consumption of the facility 1.

### Configuration of Power Management Apparatus

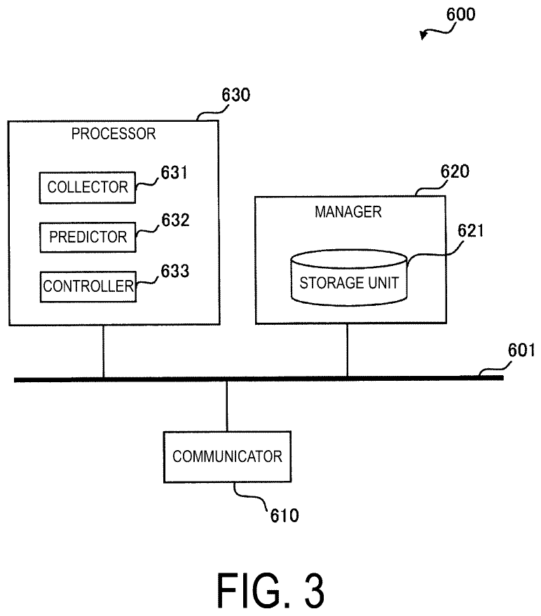

A configuration of the power management apparatus 600 according to the embodiment will be described with reference to FIG. 3. As illustrated in FIG. 3, the power management apparatus 600 includes a communicator 610, a manager 620, and a processor 630. The communicator 610, the manager 620, and the processor 630 are connected to each other by a bus 601.

The communicator 610 performs communication under the control of the processor 630. The communicator 610 may include a transmitter that performs transmission and a receiver that performs reception. For example, the communicator 610 receives sensor data from each piece of equipment (the distribution board 100, the freezer control apparatus 300, the power load 400, and the power generation equipment 500) provided in the facility 1. The communicator 610 may receive auxiliary data used for the estimation process from an external server. The communicator 610 transmits a message for controlling the equipment provided in the facility 1 to the facility. The message may be a control message for controlling the operation of the equipment. The message may be an inquiry message for inquiring the state of the equipment. For example, the communicator 610 transmits a control message for controlling the freezer 200 to the freezer control apparatus 300.

The manager 620 includes a storage 621 that stores sensor data, and manages the sensor data. The storage 621 may include, for example, various memories such as a read only memory (ROM), a random access memory (RAM), and an auxiliary storage apparatus. The storage 621 also stores a program executed by the processor 630.

The processor 630 includes at least one processor and executes a program stored in the storage 621. The at least one processor may be constituted by a single integrated circuit (IC), or may be constituted by a plurality of circuits (an integrated circuit, a discrete circuit, and/or the like) that are communicably connected. The processor 630 provides functions of a collector 631, an estimator 632, and a controller 633 by executing a program stored in the storage 621.

The collector 631 collects sensor data regarding electric power of the facility 1 including the freezer 200 and the power load 400 other than the freezer 200. Specifically, the collector 631 collects the sensor data by communicating with each piece of equipment via the communicator 610. The collector 631 may collect auxiliary data used for the estimation process from an external server via the communicator 610. The collector 631 stores the collected data in the storage 621.

The estimator 632 estimates the total power consumption of the facility 1 with the data collected by the collector 631. The estimator 632 may perform estimation using machine learning such as reinforcement learning (for example, knowledge-based, statistics-based, or neural net-based). For example, the estimator 632 performs machine learning by using the sensor data (and the auxiliary information) and the record of the total power consumption of the facility 1 as the training data, constructs a learned model for estimating (inferring) the future total power consumption of the facility 1, and estimates the future total power consumption of the facility 1 by using the learned model. The learned model includes, for example, a parameter set of an algorithm and/or a neural network constructed by machine learning.

The controller 633 controls the freezer 200 (and the power load 400) with the result of the estimation by the estimator 632. Specifically, the controller 633 creates a power plan including an operation plan of the freezer 200 (and the power load 400) from the result of the estimation by the estimator 632, and controls the freezer 200 (and the power load 400) using the created plan. Specifically, the controller 633 generates a message for controlling the freezer 200 (and the power load 400) using the plan, and transmits the message via the communicator 610. The controller 633 may create a power plan for a certain day on the previous day and appropriately modify the power plan according to the situation of the day.

For example, the estimator 632 estimates a facility peak time zone which is a time zone including the peak of the total power consumption of the facility 1 with the data collected by the collector 631. The time zone may be a time unit of a fixed time length. The time zone may be a time unit of a variable time length, but in the following description, it is assumed that the time zone is a time unit of a variable time length. The controller 633 creates the operation plan of the freezer 200 so that the peak of the power consumption of the freezer 200 occurs in a predetermined time zone prior to the estimated facility peak time zone. That is, the controller 633 causes the freezer 200 to cool the heat storage material 22 in a predetermined time zone prior to the estimated facility peak time zone. Thus, sufficient cold heat can be stored in the heat storage material 22 of the freezer warehouse 20 in the predetermined time zone prior to the facility peak time zone.

The controller 633 creates an operation plan of the freezer 200 so as to perform, as the control, a reduction control to reduce an operation of the freezer 200 in the facility peak time zone. The limit operation of the freezer 200 may be an operation for maintaining the internal temperature of the freezer warehouse 20 by using the cold storage released from the heat storage material 22. For example, the limit operation of the freezer 200 may be to stop the operation of the freezer 200. The limit operation of the freezer 200 may be intermittent operation of the freezer 200. In the limit operation of the freezer 200, the freezer 200 may be operated only when the temperature of the heat storage material 22 and/or the internal temperature of the freezer warehouse 20 is lower than a threshold.

By such control, the peak of the total power consumption of the facility 1 is reduced in preference to the reduction of the peak of the power consumption of the freezer 200, and the freezer 200 can be more efficiently controlled.

### Operation of Power Management System

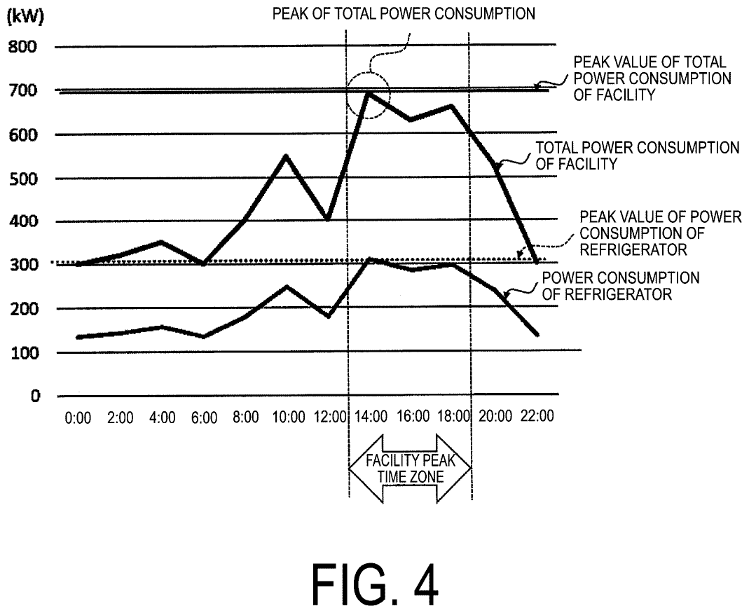

An operation example of the power management system according to the embodiment will be described with reference to FIGS. 4 to 6.

FIG. 4 illustrates the transition of power consumption per day when neither the freezer control apparatus 300 nor the power management apparatus 600 performs the peak reduction control. In the example of FIG. 4, it is assumed that the ratio of the power consumption of the freezer 200 to the total power consumption of the facility 1 is, for example, about 40%. It is noted that the ratio is merely an example.

The power consumption of the freezer 200 increases in accordance with an increase in the outside air temperature, an operation of the facility 1 (for example, opening and closing of a door for carrying-in and carrying-out, heat of carried inventory items, heat generated by a person or a forklift), and the like. In the example of FIG. 4, the power consumption of the freezer 200 starts to increase from early morning (6:00), and the power consumption of the freezer 200 reaches a peak at 14:00. The peak power consumption of the freezer 200 is about 300 kW. Thereafter, the state in which the power consumption of the freezer 200 is high continues until 18:00, and the power consumption of the freezer 200 decreases from 18:00.

The total power consumption of the facility 1 is the sum of the power consumption of the freezer 200 and the power consumption of the power load 400. The total power consumption of the facility 1 changes according to the change in the power consumption of the freezer 200, and the peak of the total power consumption of the facility 1 occurs at 14:00. The peak of the total power consumption of the facility 1 is about 700 kW. Thereafter, the state in which the total power consumption of the facility 1 is high continues until 18:00, and the total power consumption of the facility 1 decreases from 18:00. Here, 13:00 to 18:00 at which the peak of the total power consumption of the facility 1 occurs and a state in which the total power consumption is high continues is set as a facility peak time zone.

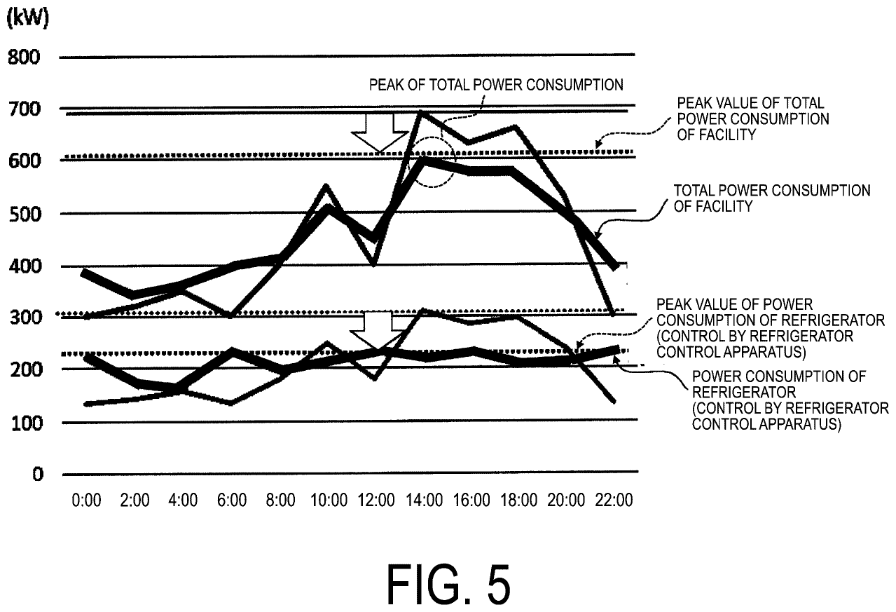

FIG. 5 illustrates a transition of power consumption per day when the freezer control apparatus 300 performs the peak reduction control. In this case, the freezer control apparatus 300 controls the freezer 200 so as to reduce the peak of the power consumption of the freezer 200, and the power consumption of the freezer 200 is equalized (averaged). As a result, the peak of the total power consumption of the facility 1 is also reduced. In the example of FIG. 5, the peak of the total power consumption of the facility 1 is about 600 kW, which is reduced by about 100 kW compared to FIG. 4. However, in the freezer control apparatus 300, only the peak reduction control closed by the freezer 200 can be performed, and the effect of reducing the peak of the total power consumption of the facility 1 is limited.

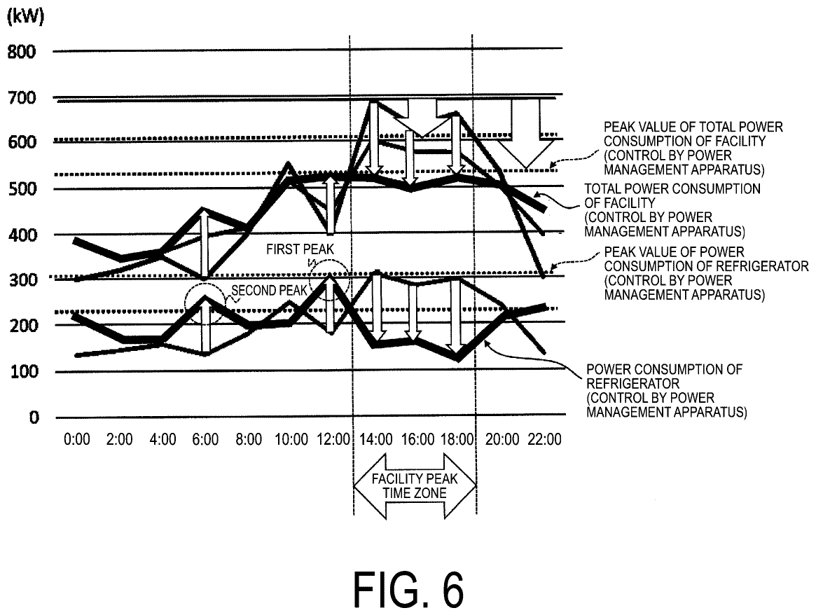

FIG. 6 illustrates the transition of power consumption per day when the power management apparatus 600 performs peak reduction control. The power management apparatus 600 controls the freezer 200 so that the peak of the total power consumption of the facility 1 is reduced in preference to the reduction of the peak of the power consumption of the freezer 200.

Specifically, the power management apparatus 600 estimates a facility peak time zone (13:00 to 18:00) and performs control such that the peak of the power consumption of the freezer 200 occurs in a predetermined time zone prior to the facility peak time zone. In the example of FIG. 6, the power management apparatus 600 performs control such that the first peak of the power consumption of the freezer 200 occurs in a time zone including 12:00, and performs control such that the second peak of the power consumption of the freezer 200 occurs in a time zone including 6:00. Thus, when the facility peak time zone starts, the heat storage material 22 in a state where sufficient cold heat is stored can be kept.

The power management apparatus 600 performs control to perform, as the control, a reduction control to reduce an operation of the freezer 200 in the facility peak time zone (13:00 to 18:00). Here, the power management apparatus 600 reduces the power consumption of the freezer 200 while maintaining the internal temperature of the freezer warehouse 20 by using the cold storage released from the heat storage material 22. Therefore, the power consumption of the freezer 200 is significantly reduced in the facility peak time zone. As a result, the peak of the total power consumption of the facility 1 is also significantly reduced in the facility peak time zone. In the example of FIG. 6, the peak of the total power consumption of the facility 1 is about 530 kW, and the peak of the total power consumption of the facility 1 is reduced by about 170 kW as compared with FIG. 4.

In the embodiment, as illustrated in FIG. 6, the power management apparatus 600 controls the freezer 200 so as to reduce the peak of the total power consumption of the facility 1. This makes it possible to further reduce the peak values of the total power consumption of the facility 1 as compared with the case where the freezer control apparatus 300 controls the freezer 200 so as to reduce the peak of the power consumption of the freezer 200 (see FIG. 5).

Here, in the example of FIG. 6, the power management apparatus 600 determines a time zone including 6:00 and a time zone including 12:00 as the predetermined time zone, and performs control such that the peak of the power consumption of the freezer 200 occurs in the determined predetermined time zone. Specifically, the power management apparatus 600 cools the heat storage material 22 by the freezer 200 in the determined predetermined time zone, and causes the heat storage material 22 to store cold heat. As a method of determining such a predetermined time, one of the following methods (a) to (e) or a combination of two or more methods can be used.

(a) Methods with an Outside Air Temperature, an Outside Humidity or Combination Thereof

The estimator 632 of the power management apparatus 600 estimates the outside air temperature, the outside humidity or combination thereof for each time zone. For example, the estimator 632 of the power management apparatus 600 estimates the outside air temperature, the outside humidity or combination thereof on an hourly basis. As a method of estimating the outside air temperature, the outside humidity or combination thereof, a method with learning, a method with weather forecast data from an external server, or the like can be used. The controller 633 of the power management apparatus 600 performs control such that the peak of the power consumption of the freezer 200 occurs in a predetermined time zone in which the estimated the outside air temperature, the outside humidity or combination thereof satisfies a predetermined criterion.

Generally, the lower the outside air temperature, the outside humidity or combination thereof, the higher the efficiency of the freezer 200. That is, if the freezer 200 is operated when the outside air temperature, the outside humidity or combination thereof is low, a high cooling effect can be obtained with low power consumption. For example, the controller 633 of the power management apparatus 600 determines, as the predetermined time zone, a time zone that is prior to the estimated facility peak time zone and in which the estimated the outside air temperature, the outside humidity or combination thereof is lowest or the estimated the outside air temperature, the outside humidity or combination thereof is lower than a threshold. As a result, the power consumption of the freezer 200 can be efficiently reduced.

(b) Methods with the Generated Power

The estimator 632 of the power management apparatus 600 estimates the generated power of the power generation equipment 500 for each time zone. For example, the estimator 632 of the power management apparatus 600 estimates the generated power (kWh) on an hourly basis. As a method of estimating the generated power, for example, when the power generation equipment 500 is a photovoltaic power generation equipment, a method with learning, a method with weather forecast data from an external server, or the like can be used. The controller 633 of the power management apparatus 600 performs control such that the peak of the power consumption of the freezer 200 occurs in a predetermined time zone in which the estimated generated power satisfies a predetermined criterion.

For example, the controller 633 of the power management apparatus 600 determines, as the predetermined time zone, a time zone that is prior to the estimated facility peak time zone and in which the estimated generated power is the largest or the estimated generated power is larger than a threshold. As a result, the generated power by the power generation equipment 500 can be effectively utilized.

(c) Methods with the Carbon Dioxide Emissions Coefficient

The estimator 632 of the power management apparatus 600 estimates a carbon dioxide emissions coefficient for each time zone. The carbon dioxide emissions coefficient represents the carbon dioxide emissions emitted when the electric power of 1 kWh is generated as an emission coefficient. With the spread of renewable energies, the carbon dioxide emissions are considered to change depending on the time zone. As a method of estimating the carbon dioxide emissions coefficient, a learning-based method, a data-based method from an external server, or the like can be used. The controller 633 of the power management apparatus 600 performs control such that the peak of the power consumption of the freezer 200 occurs in a predetermined time zone in which the estimated carbon dioxide emissions coefficient satisfies a predetermined criterion.

For example, the controller 633 of the power management apparatus 600 determines, as the predetermined time zone, a time zone that is prior to the estimated facility peak time zone and in which the estimated carbon dioxide emissions coefficient is the smallest or the estimated carbon dioxide emissions coefficient is smaller than a predetermined value. This can contribute to a limit of an increase in carbon dioxide emissions.

(d) Method with the Electric Power Wholesale Price

An estimator 632 of a power management apparatus 600 estimates an electric power wholesale price for each time zone. The electric power wholesale price is a transaction price in the electric power market, and varies according to the supply-demand balance of electric power. As a method of estimating the electric power wholesale price, a method with learning, a method with data from an external server, or the like can be used. The controller 633 of the power management apparatus 600 performs control such that the peak of the power consumption of the freezer 200 occurs in a predetermined time zone in which the electric power wholesale price satisfies a predetermined criterion.

For example, the controller 633 of the power management apparatus 600 determines, as the predetermined time zone, a time zone that is prior to the estimated facility peak time zone and in which the estimated power wholesale price is the lowest or the estimated electric power wholesale price is lower than a threshold. Accordingly, the freezer 200 can be caused to efficiently consume electric power in a time zone in which the supply amount of electric power is large. When the electric power wholesale price is linked with the electric power rate of the facility 1, the cooling cost of the freezer 200 can be reduced.

(e) Method with the Thermal Load of the Freezer Warehouse

The estimator 632 of the power management apparatus 600 estimates the thermal load of the freezer warehouse 20 for each time zone. The thermal load of the freezer warehouse 20 refers to the amount of heat required to maintain the internal temperature of the freezer warehouse 20 at a constant temperature (and a constant humidity), and can be expressed in units of, for example, the amount of heat required per unit time (kcal/h). For example, the time zone in which the door of the freezer warehouse 20 is opened corresponds to the time zone in which the thermal load of the freezer warehouse 20 is high. As a method of estimating the thermal load of the freezer warehouse 20, a method with learning, a method with data from an external server, or the like can be used.

The controller 633 of the power management apparatus 600 performs control such that the peak of the power consumption of the freezer 200 occurs in a predetermined time zone in which the estimated thermal load of the freezer warehouse 20 satisfies a predetermined criterion. For example, the controller 633 of the power management apparatus 600 determines, as the predetermined time zone, a time zone that is prior to the estimated facility peak time zone and in which the estimated thermal load of the freezer warehouse 20 is the lowest or the estimated thermal load of the freezer warehouse 20 is lower than a threshold. As a result, the power consumption of the freezer 200 can be efficiently reduced.

(f) Method with the electric power price by time zone

The collector 631 of the power management apparatus 600 acquires a fixed power price for each time zone defined in the contract. The fixed power price for each time zone defined by the contract may be defined by a contract between the consumer and the electric power retailer. The controller 633 of the power management apparatus 600 performs control such that the peak of the power consumption of the freezer 200 occurs in the predetermined time zone determined with the power price.

For example, the controller 633 of the power management apparatus 600 determines, as the predetermined time zone, a time zone that is prior to the estimated facility peak time zone and in which the power price for each time zone defined in the contract is the lowest. Accordingly, the freezer 200 can be caused to efficiently consume electric power in a time zone in which the price of electric power is low.

### Power Management Method

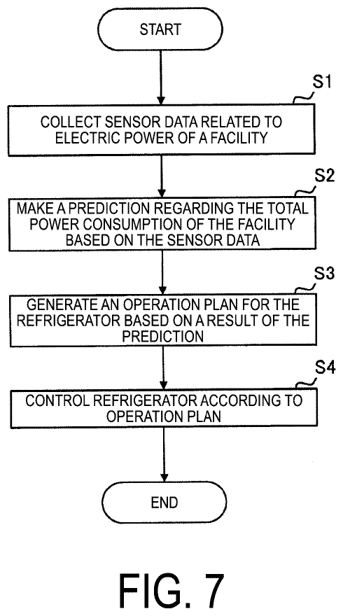

A power management method performed by the power management apparatus 600 according to the embodiment will be described with reference to FIG. 7.

In step S1, the collector 631 of the power management apparatus 600 collects data about the power of the facility 1. Specifically, the collector 631 of the power management apparatus 600 collects the sensor data by communicating with each equipment of the facility 1. The collector 631 of the power management apparatus 600 may collect auxiliary data used for the estimation process from an external server.

In step S2, the estimator 632 of the power management apparatus 600 estimates the total power consumption of the facility 1 with the data collected in step S1. In the embodiment, the estimator 632 of the power management apparatus 600 estimates a facility peak time zone, which is a time zone including the peak of the total power consumption of the facility 1, with the data collected by the collector 631. The estimator 632 of the power management apparatus 600 may further estimate a parameter for determining a predetermined time zone prior to the estimated facility peak time zone, for example, at least one selected from the group consisting of the outside air temperature, the generated power, the carbon dioxide emissions coefficient, the electric power wholesale price, and the thermal load of the freezer warehouse 20.

In step S3, the controller 633 of the power management apparatus 600 creates an operation plan of the freezer 200 so that the peak of the power consumption of the freezer 200 occurs in a predetermined time zone prior to the facility peak time zone estimated in step S2. The predetermined time zone is determined with the above-described parameters. The controller 633 of the power management apparatus 600 creates an operation plan of the freezer 200 so as to perform, as the control, a reduction control to reduce an operation of the freezer 200 in the facility peak time zone.

estimated in step S2. The controller 633 of the power management apparatus 600 may create the operation plan of the power load 400 so as to perform, as the control, a reduction control to reduce the operation of the power load 400 in the facility peak time zone estimated in step S2.

In step S4, the controller 633 of the power management apparatus 600 controls the freezer 200 in accordance with the operation plan created in step S3.

### First Modification of Power Management System

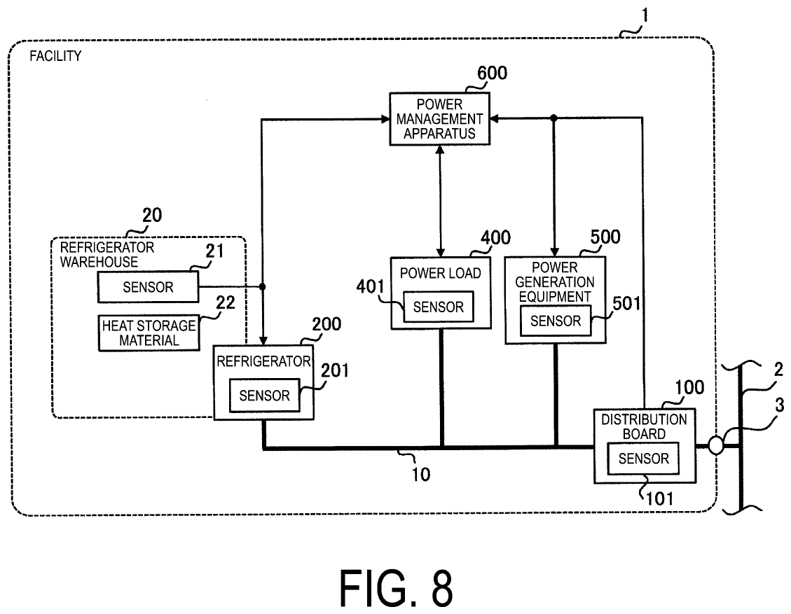

A first modification of the power management system according to the above-described embodiment will be described with reference to FIG. 8.

As illustrated in FIG. 8, the power management system according to the present modification does not include the freezer control apparatus 300 described above. To be specific, in the present modification, the power management apparatus 600 is provided with the function of the freezer control apparatus 300 described above, and the power management apparatus 600 is configured integrally with the freezer control apparatus 300. In such a configuration, the power management apparatus 600 can control the freezer 200 without using the freezer control apparatus 300. The freezer 200 may have the function of the freezer control apparatus 300 described above, and the freezer 200 may be configured integrally with the freezer control apparatus 300.

### Second Modification of Power Management System

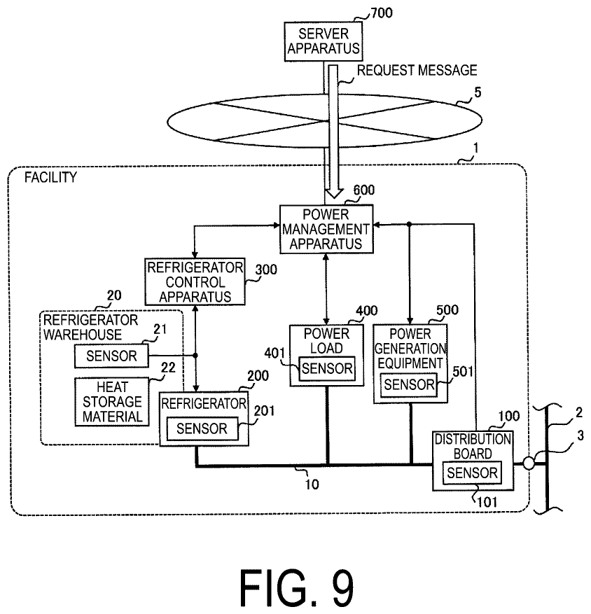

A second modification of the power management system according to the above-described embodiment will be described with reference to FIG. 9. This modification may be implemented in combination with the above-described first modification.

As illustrated in FIG. 9, in the power management system according to the present modification, the power management apparatus 600 communicates with a server apparatus 700 via the communication network 5. The server apparatus 700 is an example of an external apparatus and is, for example, an apparatus managed by an electric power company (including an aggregator). The server apparatus 700 requests the power management apparatus 600 to adjust the supply-demand balance of electric power. Such a request may be referred to as a demand response (DR) request.

The communicator 610 of the power management apparatus 600 receives, from the server apparatus 700, a request message requesting a limit or an acceleration of the power consumption in the facility 1. The request message may include information for designating a time zone in which a limit or an acceleration of the power consumption in the facility 1 is requested. The request message may include information for designating the amount of a limit or the amount of an acceleration of the power consumption in the facility 1.

In the present modification, the estimator 632 of the power management apparatus 600 may estimate whether or not the limit of the power consumption in the facility 1 (so-called lowering DR) is requested from the server apparatus 700. As a method of the estimation, a method with learning, a method with data from an external server, or the like can be used. For example, the estimator 632 of the power management apparatus 600 estimates a time zone in which the shortage of the power of the area to which the facility 1 belongs is estimated as the time zone in which the limit of the power consumption in the facility 1 is requested. The controller 633 of the power management apparatus 600 performs control such that the peak of the power consumption of the freezer 200 occurs in a time zone prior to the estimated time zone in which the limit is requested (that is, performs control such that the freezer 200 performs cooling of the heat storage material 22). Here, the time zone in which the peak of the power consumption of the freezer 200 occurs may be the above-described predetermined time zone.

In the present modification, estimator 632 of power management apparatus 600 may estimate whether or not the acceleration of power consumption in facility 1 (so-called increase DR) is requested from server apparatus 700. As a method of the estimation, a method with learning, a method with data from an external server, or the like can be used. For example, the estimator 632 of the power management apparatus 600 estimates a time zone in which surplus power is estimated to be generated in the area to which the facility 1 belongs, as a time zone in which the acceleration of the power consumption in the facility 1 is requested. The controller 633 of the power management apparatus 600 performs control such that the peak of the power consumption of the freezer 200 occurs in the estimated time zone in which the acceleration is requested (that is, performs control such that the cool of the heat storage material 22 is performed by the freezer 200).

In the present modification, the communicator 610 of the power management apparatus 600 may receive, from the server apparatus 700, a request message requesting the acceleration of the power consumption in the facility 1. When the communicator 610 receives the request message, the controller 633 of the power management apparatus 600 performs control such that the peak of the power consumption of the freezer 200 occurs in the time zone in which the acceleration of the power consumption is requested by the request message (that is, performs control such that the cool of the heat storage material 22 is performed by the freezer 200).

### Third Modification of Power Management System

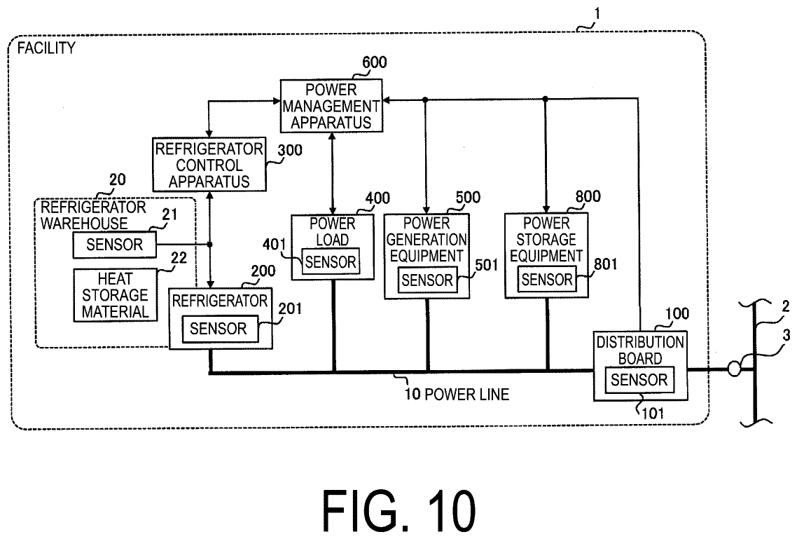

A third modification of the power management system according to the above-described embodiment will be described with reference to FIG. 10. This modification may be implemented in combination with the first modification and/or the second modification described above.

As illustrated in FIG. 10, in the present modification, the facility 1 includes a power storage equipment (storage battery) 800. The power storage equipment 800 is an apparatus that stores electric power. The power storage equipment 800 performs a charging operation of storing electric power supplied from the power grid 2 and/or the power generation equipment 500 via the power line 10 under the control of the power management apparatus 600. The power storage equipment 800 performs a discharging operation of outputting electric power to the freezer 200 and the power load 400 via the electric power line 10 under the control of the power management apparatus 600. The power storage equipment 800 may include a sensor 801 for detecting a charge/discharge amount and/or a power storage remaining amount of the power storage equipment 800. The power storage equipment 800 outputs sensor data obtained by the sensor 801 to the power management apparatus 600.

In the present modification, when the freezer 200 cannot be controlled, for example, when the freezer control apparatus 300 or the freezer 200 notifies the power management apparatus 600 of control NG, the controller 633 of the power management apparatus 600 may perform the peak reduction control using the power storage equipment 800. That is, when the facility 1 includes the power storage equipment 800 and the freezer 200 cannot be controlled, the controller 633 of the power management apparatus 600 controls the power storage equipment 800 so that the peak of the total power consumption of the facility 1 is reduced.

As described above, the estimator 632 of the power management apparatus 600 estimates the facility peak time zone, which is the time zone including the peak of the total power consumption of the facility 1, with the data collected by the collector 631. The controller 633 of the power management apparatus 600 creates the operation plan of the freezer 200 so that the peak of the power consumption of the freezer 200 occurs in a predetermined time zone prior to the estimated facility peak time zone. That is, the controller 633 causes the freezer 200 to cool the heat storage material 22 in a predetermined time zone prior to the estimated facility peak time zone.

However, for some reason, for example, when the freezer control apparatus 300 or the freezer 200 notifies the power management apparatus 600 of control NG, the freezer 200 may not be controlled. In such a case, the controller 633 of the power management apparatus 600 may control the power storage equipment 800 to perform the charging operation in the above-described predetermined time zone instead of cooling the heat storage material 22 by the freezer 200. The controller 633 of the power management apparatus 600 may control the power storage equipment 800 to perform the discharging operation in the facility peak time zone. Thus, even when the freezer 200 cannot be controlled, the peak reduction effect can be obtained by the control of the power management apparatus 600.

### Other Embodiments

In the above-described embodiment, an example in which the power management apparatus 600 performs the peak reduction control of the total power consumption of the facility 1 using the freezer 200 has been mainly described. However, the controller 633 of the power management apparatus 600 may control the freezer 200 and the power load 400 so that the peak of the total power consumption of the facility 1 is reduced in preference to the reduction of the peak of the power consumption of the freezer 200. In particular, the facility 1 may be a warehouse facility, the power load 400 may include warehouse equipment, and the controller 633 of the power management apparatus 600 may control the freezer 200 and the warehouse equipment such that the peak of the total power consumption of the warehouse facility is reduced in preference to the reduction of the peak of the power consumption of the freezer 200. Such warehouse equipment may be specific warehouse equipment which is not used all the time but is used temporarily and whose power consumption when used is larger than a predetermined value. For example, the specific warehouse equipment available for peak reduction control may be a pallet washer and/or a forklift charger. A pallet washer is equipment for washing pallets used in warehouse facilities. The forklift charger is equipment for charging a forklift used in a warehouse facility.

For example, the estimator 632 of the power management apparatus 600 estimates a facility peak time zone, which is a time zone including the peak of the total power consumption of the facility 1, with the data collected by the collector 631. The controller 633 of the power management apparatus 600 creates the operation plan of the specific warehouse equipment such that the peak of the power consumption of the specific warehouse equipment occurs in a predetermined time zone prior to the estimated facility peak time zone. That is, the controller 633 of the power management apparatus 600 operates the specific warehouse equipment in a predetermined time zone prior to the estimated facility peak time zone. The controller 633 of the power management apparatus 600 creates the operation plan of the specific warehouse equipment so as to perform, as the control, a reduction control to reduce the operation of the specific warehouse equipment in the estimated facility peak time zone. The restricted operation of the specific warehouse equipment may be to stop the operation of the specific warehouse equipment.

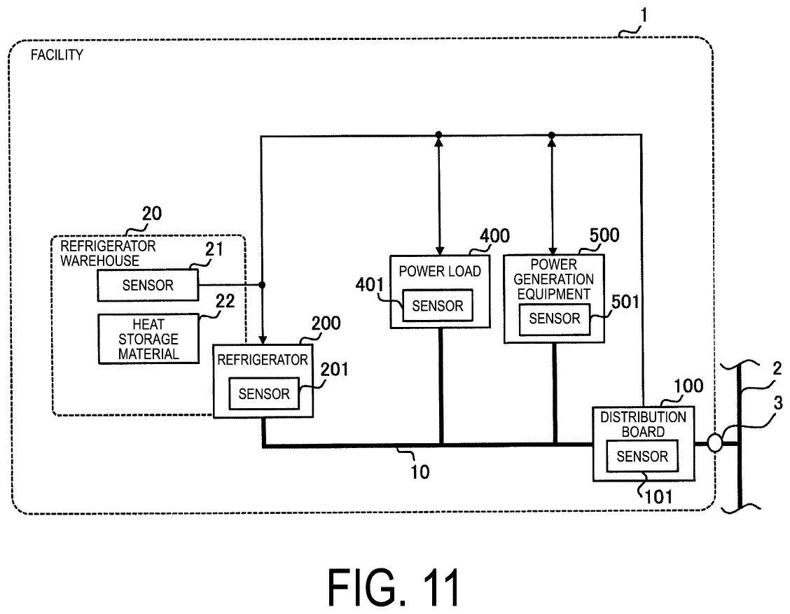

In the above-described embodiment, an example in which the power management apparatus 600 is provided separately from the freezer 200 has been mainly described. However, as illustrated in FIG. 11, the freezer 200 may have the function of the power management apparatus 600, and the power management apparatus 600 may be integrated with the freezer 200. In such a modification example, the freezer 200 includes the communicator 610, the manager 620, and the processor 630 described above. The processor 630 includes the collector 631, the estimator 632, and the controller 633 described above.

A program that executes in the computer to perform operations according to the embodiments described above may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited. For example, recording media such as a CD-ROM and a DVD-ROM may be used. A semiconductor integrated circuit (chip set, SoC: System on a chip) may be configured by integrating circuits that execute the operations performed in the above-described embodiments.

The phrases “with” and “depending on” used in the present disclosure do not mean “with on” and “only depending on,” unless specifically stated otherwise. The phrase “with” means both “with on” and “based at least in part on”. The phrase “depending on” means both “only depending on” and “at least partially depending on”. The phrases “collect” and “obtain/acquire” may mean that information is obtained from stored information, may mean that information is obtained from information received from another node, or may mean that information is obtained by generating the information. The terms “include” and “comprise” do not imply the inclusion of only the listed items but rather the inclusion of only the listed items or the inclusion of additional items in addition to the listed items. The term “or” used in the present disclosure is not intended to be “exclusive or”. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

The present application claims priority to Japanese Patent Application No. 2022-84154 (filed on May 23, 2022), the contents of which are incorporated herein by reference in their entirety.

### Supplementary Note

The features of the above-described embodiment will be additionally described.

### Supplementary Note 1

A power management apparatus including:
a collector configured to collect data related to electric power of a facility including a freezer and a power load other than the freezer;
an estimator configured to perform an estimation of total power consumption of the facility with the data; and
a controller configured to perform a control of the freezer with a result of the estimation, wherein
the controller is configured to perform the control to prioritize a reduction of a peak in the total power consumption of the facility over a reduction of a peak in power consumption of the freezer.

### Supplementary Note 2

The power management apparatus according to Supplementary Note 1, wherein the controller is configured to perform the control of the freezer and the power load to prioritize the reduction of the peak in the total power consumption of the facility over the reduction of the peak in the power consumption of the freezer.

### Supplementary Note 3

The power management apparatus according to Supplementary Note 2, wherein the facility is a warehouse facility, and the power load includes warehouse equipment, and the controller is configured to perform the control of the freezer and the warehouse equipment to prioritize the reduction of the peak in total power consumption of the warehouse facility over the reduction of the peak in the power consumption of the freezer.

### Supplementary Note 4

The power management apparatus according to any one of Supplementary Notes 1 to 3, wherein the estimator is configured to estimate a facility peak time zone, which is a time zone including the peak in the total power consumption of the facility, with the data, and the controller is configured to perform the control to occur the peak in the power consumption of the freezer in a predetermined time zone prior to the facility peak time zone.

### Supplementary Note 5

The power management apparatus according to Supplementary Note 4, wherein the controller is configured to perform, as the control, a reduction control to reduce an operation of the freezer in the facility peak time zone.

### Supplementary Note 6

The power management apparatus according to Supplementary Note 4 or 5, wherein the controller is configured to cause the freezer to cool a heat storage material by the freezer in the predetermined time zone.

### Supplementary Note 7

The power management apparatus according to any one of Supplementary Notes 4 to 6, wherein the estimator is configured to estimate an outside air temperature, an outside and/or humidity or combination thereof for each time zone, and
the controller is configured to perform the control to occur the peak in the power consumption of the freezer in the predetermined time zone in which the outside air temperature, the outside humidity or combination thereof satisfies a predetermined criterion.

### Supplementary Note 8

The power management apparatus according to any one of Supplementary Notes 4 to 7, wherein when the facility includes power generation equipment, the estimator is configured to estimate generated power of the power generation equipment for each time zone, and
the controller is configured to perform the control to occur the peak in the power consumption of the freezer in the predetermined time zone in which the generated power satisfies a predetermined criterion.

### Supplementary Note 9

The power management apparatus according to any one of Supplementary Notes 4 to 8, wherein the estimator is configured to estimate a carbon dioxide emissions coefficient for each time zone, and
the controller is configured to perform the control to occur the peak in the power consumption of the freezer in the predetermined time zone in which the carbon dioxide emissions coefficient satisfies a predetermined criterion.

### Supplementary Note 10

The power management apparatus according to any one of Supplementary Notes 4 to 9, wherein the estimator is configured to estimate an electric power wholesale price for each time zone, and
the controller is configured to perform the control to occur the peak in the power consumption of the freezer in the predetermined time zone in which the electric power wholesale price satisfies a predetermined criterion.

### Supplementary Note 11

The power management apparatus according to any one of Supplementary Notes 4 to 10, wherein
the estimator is configured to estimate a thermal load of a freezer warehouse in the facility for each time zone, and
the controller is configured to perform the control to occur the peak in the power consumption of the freezer in the predetermined time zone in which the thermal load satisfies a predetermined criterion.

### Supplementary Note 12

The power management apparatus according to any one of Supplementary Notes 1 to 11, wherein
the estimator is configured to estimate whether or not a limit of the power consumption in the facility is requested from an external apparatus, and
the controller is configured to perform the control to occur the peak in the power consumption of the freezer in a time zone prior to an estimated time zone in which the limit is requested.

### Supplementary Note 13

The power management apparatus according to any one of Supplementary Notes 1 to 12, wherein
the estimator is configured to estimate whether an acceleration of the power consumption in the facility is requested from an external apparatus, and
the controller is configured to perform the control to occur the peak in the power consumption of the freezer in an estimated time zone in which the acceleration is requested.

### Supplementary Note 14

The power management apparatus according to any one of Supplementary Notes 1 to 13, further including
a communicator configured to receive a request message to request an acceleration of the power consumption in the facility from an external apparatus, wherein
the controller is configured to perform the control to occur the peak in the power consumption of the freezer in a time zone in which the acceleration is requested by the request message.

### Supplementary Note 15

The power management apparatus according to any one of Supplementary Notes 1 to 14, wherein
when the facility includes power storage equipment and control of the freezer is unable to be performed, the controller is configured to perform the control of the power storage equipment to reduce the peak in the total power consumption of the facility.

### Supplementary Note 16

A power management method including:
collecting data related to electric power of a facility including a freezer and a power load other than the freezer;
estimating total power consumption of the facility with the data; and
performing a control of the freezer with a result of the estimation, wherein
the performing the control includes performing the control to prioritize the reduction of a peak in the total power consumption of the facility over a reduction of a peak in power consumption of the freezer.

### Supplementary Note 17

A power management program executing in a computer:
collecting data related to electric power of a facility including a freezer and a power load other than the freezer;
estimating total power consumption of the facility with the data; and
performing a control of the freezer with a result of the estimation, wherein
the performing the control includes performing the control to prioritize a reduction of a peak in the total power consumption of the facility over a reduction of a peak in power consumption of the freezer.

### Supplementary Note 18

A facility including a freezer and a power load other than the freezer, wherein the facility includes:
a collector configured to collect data related to electric power of the facility;
an estimator configured to estimate total power consumption of the facility with the data; and
a controller configured to perform a control of the freezer with a result of the estimation, wherein
the controller is configured to perform the control to prioritize a reduction of a peak in the total power consumption of the facility over a reduction of a peak in power consumption of the freezer.

### Supplementary Note 19

A freezer including:
a collector configured to collect data related to electric power of a facility including a freezer and a power load other than the freezer;
an estimator configured to estimate total power consumption of the facility with the data; and
a controller configured to perform a control of the freezer with a result of the estimation, wherein
the controller is configured to perform the control to prioritize a reduction of a peak in the total power consumption of the facility over a reduction of a peak in power consumption of the freezer.

### REFERENCE SIGNS

1: Facility
2: Power grid
3: Power receiving point
5: Communication network
10: Power line
20: Freezer warehouse
21: Sensor
22: Heat storage material
30: Freezer warehouse
40: Room temperature warehouse
50: Restaurant
100: Distribution board
101: Sensor
200: Freezer
201: Sensor
300: Freezer control apparatus
400: Power load
401: Sensor
410: Air conditioner
420: Lighting equipment
430: Conveyor/automation apparatus
450: Office equipment
500: Power generation equipment
501: Sensor
600: Power management apparatus
601: Bus
610: Communicator
620: Manager
621: Storage
630: Processor
631: Collector
632: Estimator
633: Controller
700: Server apparatus
800: Power storage equipment

1. A power management apparatus comprising:
a collector configured to collect data related to electric power of a facility comprising a freezer and a power load other than the freezer;
an estimator configured to perform an estimation of total power consumption of the facility with the data; and
a controller configured to perform a control of the freezer with a result of the estimation, wherein
the controller is configured to perform the control to prioritize a reduction of a peak in the total power consumption of the facility over a reduction of a peak in power consumption of the freezer.

2. The power management apparatus according to claim 1, wherein
the controller is configured to perform the control of the freezer and the power load to prioritize a reduction of the peak in the total power consumption of the facility over the a reduction of the peak in the power consumption of the freezer.

3. The power management apparatus according to claim 2, wherein
the facility is a warehouse facility, and the power load comprises warehouse equipment, and
the controller is configured to perform the control of the freezer and the warehouse equipment to prioritize the reduction of peak in the total power consumption of the warehouse facility over the reduction of the peak in the power consumption of the freezer.

4. The power management apparatus according to claim 1, wherein
the estimator is configured to estimate a facility peak time zone, which is a time zone comprising the peak in the total power consumption of the facility, with the data, and
the controller is configured to perform the control to occur the peak in the power consumption of the freezer in a predetermined time zone prior to the facility peak time zone.

5. The power management apparatus according to claim 4, wherein
the controller is configured to perform, as the control, a reduction control to reduce an operation of the freezer in the facility peak time zone.

6. The power management apparatus according to claim 4, wherein
the controller is configured to cause the freezer to cool a heat storage material by the freezer in the predetermined time zone.

7. The power management apparatus according to claim 4, wherein
the estimator is configured to estimate an outside air temperature, an outside humidity or combination thereof for each time zone, and
the controller is configured to perform the control to occur the peak in the power consumption of the freezer in the predetermined time zone in which the outside air temperature, the outside humidity or combination thereof satisfies a predetermined criterion.

8. The power management apparatus according to claim 4, wherein
the facility comprises a power equipment;
the estimator is configured to predict generated power of the power generation equipment for each time zone, and
the controller is configured to perform the control to occur the peak in the power consumption of the freezer in the predetermined time zone in which the generated power satisfies a predetermined criterion.

9. The power management apparatus according to claim 4, wherein
the estimator is configured to estimate a carbon dioxide emissions coefficient for each time zone, and
the controller is configured to perform the control to occur the peak in the power consumption of the freezer in the predetermined time zone in which the carbon dioxide emissions coefficient satisfies a predetermined criterion.

10. The power management apparatus according to claim 4, wherein
the estimator is configured to estimate an electric power wholesale price for each time zone, and
the controller is configured to perform the control to occur the peak in the power consumption of the freezer in the predetermined time zone in which the electric power wholesale price satisfies a predetermined criterion.

11. The power management apparatus according to claim 4, wherein
the estimator is configured to estimate a thermal load of a freezer warehouse in the facility for each time zone, and
the controller is configured to perform the control to occur the peak in the power consumption of the freezer in the predetermined time zone in which the thermal load satisfies a predetermined criterion.

12. The power management apparatus according to claim 1, wherein
the estimator is configured to estimate whether a limit of the power consumption in the facility is requested from an external apparatus, and
the controller is configured to perform the control to occur the peak in the power consumption of the freezer in a time zone prior to an estimated time zone in which the limit is requested.

13. The power management apparatus according to claim 1, wherein
the estimator is configured to estimate whether an acceleration of the power consumption in the facility is requested from an external apparatus, and
the controller is configured to perform the control to occur the peak in the power consumption of the freezer in an estimated time zone in which the acceleration is requested.

14. The power management apparatus according to claim 1, further comprising a communicator configured to receive a request message to request an acceleration of the power consumption in the facility from an external apparatus, wherein
the controller is configured to perform the control to occur the peak in the power consumption of the freezer in a time zone in which the acceleration is requested by the request message.

15. The power management apparatus according to claim 1, wherein
when the facility comprises power storage equipment and control of the freezer is unable to be performed, the controller is configured to perform the control of the power storage equipment to reduce the peak in the total power consumption of the facility.

16. (canceled)

17. A power management program executed in a computer, the power management program comprising:
collecting data related to electric power of a facility comprising a freezer and a power load other than the freezer;
estimating total power consumption of the facility with the data; and
performing a control of the freezer with a result of the estimation, wherein
the performing the control comprises performing the control to prioritize a reduction of a peak in the total power consumption of the facility over a reduction of a peak in power consumption of the freezer.

18. (canceled)

19. A freezer comprising:
a collector configured to collect data related to electric power of a facility comprising a freezer and a power load other than the freezer;
an estimator configured to estimate total power consumption of the facility with the data; and
a controller configured to perform a control of the freezer with a result of the estimation, wherein
the controller is configured to perform the control to prioritize a reduction of a peak in the total power consumption of the facility over a reduction of a peak in power consumption of the freezer.
